(19) United States
(12) Patent Application Publication
(10) Pub. No.: US 2015/0143886 A1
(43) Pub. Date: May 28, 2015

(54) TIRE SIDEWALL CRACK INSPECTION TOOL AND METHOD OF USE

(71) Applicant: Tread Gauge Ptr, LLC, Soutbury, CT (US)

(72) Inventors: Dean Rotatori, Naugatuck, CT (US); Arthur Scott McClure, Southbury, CT (US); John Chapdelaine, Southbury, CT (US)

(21) Appl. No.: 14/400,653

(22) PCT Filed: May 15, 2013
(86) PCT No.: PCT/US13/41152

§ 371 Date: Nov. 12, 2014

Related U.S. Application Data
(60) Provisional application No. 61/749,562, filed on Jan. 7, 2013.
(60) Provisional application No. 61/647,812, filed on May 16, 2012.

(51) Int. Cl. G01M 17/02

(52) U.S. Cl. CPC G01M 17/027
USPC 73/146

(57) ABSTRACT

A method of determining crack condition on a sidewall of a tire uses a crack detection tool having a lens on a housing, and a transparent reticle on the housing at the focal plane of the lens. A plurality of spaced lines are provided on the reticle, with the spacing of each pair of indicia conforming to a degree of crack condition of the sidewall of a desired tire. The method includes viewing the sidewall of the desired tire through the lens and the reticle, selecting a crack on the tire sidewall and positioning the reticle over the selected crack so that the sides of the crack are approximately symmetrically located within, on or outside of the pairs of lines. Using the pairs of indicia on the reticle, the tire sidewall condition may be determined based on the degree of crack width.

### RELATED APPLICATIONS

This application claims priority to U.S. application Ser. No. 61/749,562, filed Jan. 7, 2013, and U.S. application Ser. No. 61/647,812, filed May 16, 2012.

### BACKGROUND OF THE INVENTION

1. Field of the Invention

The present invention relates to the inspection of tires and a tool for inspecting cracks on tire sidewalls and determining the condition thereof

2. Description of Related Art

Tires used on automobiles, trucks and other motor vehicles are critical to the safety of those who are in and around such vehicles. As shown in FIGS. 1 and 2, a tire 20 mounted on rim 24 is subject to normal deterioration in use by wear of treads 22. Additionally, cracks 30 may develop in the sidewall 26 of the tire, whether by abuse through contact with curbs or potholes or running while flat, or due to the deterioration of the rubber composition over time. Regardless of the cause, the cracks 30 can develop to be of major concern so that tire replacement is necessary, regardless of the tread 22 wear

At present, the determination of tire safety based on sidewall crack configuration is somewhat subjective, with few guidelines available. Michelin has produced a tire sidewall cracking chart which illustrates pictorially different views of sidewall cracks that it categorizes as acceptable, suspect or reject. Crack depth is also categorized. However, a user has little or no guidance of how to inspect a tire sidewall and objectively categorize the relative safety of the tire.

### SUMMARY OF THE INVENTION

Bearing in mind the problems and deficiencies of the prior art, it is therefore an object of the present invention to provide an improved method of determining crack condition on a sidewall of a tire.

It is another object of the present invention to provide a tire sidewall crack inspection tool for determining and categorizing crack condition.

A further object of the invention is to provide a method and tool for determining sidewall crack condition based on its width.

It is yet another object of the present invention to provide a method and tool for determining sidewall crack condition that is easy to carry and use in the field.

Still other objects and advantages of the invention will in part be obvious and will in part be apparent from the specification.

The above and other objects, which will be apparent to those skilled in the art, are achieved in the present invention which is directed to a method of determining crack condition on a sidewall of a tire comprising providing a crack detection tool having a housing, a lens secured on the housing, and at least one substantially transparent reticle positionable on the housing at the focal plane of the lens. A plurality of spaced pairs of indicia are provided on a central portion of the at least one reticle, with the spacing of each pair of indicia conforming to a degree of crack condition of the sidewall of a desired tire. The method then includes aligning the at least one reticle against the sidewall of the desired tire, viewing the sidewall of the desired tire through the lens and the at least one reticle, selecting a crack on the tire sidewall, the crack having a length and a width and sides along the width, and positioning the reticle over the selected crack so that the sides of the crack are approximately symmetrically located within, on or outside of the pairs of indicia. The method further includes using the pairs of indicia on the reticle, and determining the tire sidewall condition based on the degree of crack width.

The method may include providing a plurality of different substantially transparent reticles positionable on the housing at a focal point of the lens, with each reticle being associated with a different type of tire. Each reticle has a plurality of pairs of indicia marked on a central portion at different spacing on a central portion thereof, with each indicia spacing conforming to a degree of crack width indicating condition of the sidewall of different tires. The method then includes selecting a reticle for a desired tire, aligning the selected reticle against the sidewall of the desired tire, viewing the sidewall of the desired tire through the lens and the at least one reticle, selecting a crack on the tire sidewall, the crack having a length and a width and sides along the width, positioning the reticle over the selected crack so that the sides of the crack are approximately symmetrically located within, on or outside of the pairs of indicia. The method further includes using the pairs of indicia on the reticle, determining the tire sidewall condition based on the degree of crack width.

The crack selected comprises the largest visible crack on the tire sidewall, or any other desired crack.

In another aspect, the present invention is directed to a tire sidewall crack inspection tool comprising a tool housing, a lens secured on the housing and at least one substantially transparent reticle positionable on the housing at a focal plane of the lens. The at least one reticle is associated with a desired type of tire. The inspection tool further includes a plurality of spaced pairs of indicia marked on a central portion of the at least one reticle, with the spacing of each pair of indicia conforming to a different degree of crack condition of the sidewall of a desired tire. The reticle for the desired tire may be aligned against the sidewall of the desired tire to permit viewing of a crack on the sidewall of the desired tire through the lens and the plurality of pairs of indicia on the reticle may be used to determine the tire sidewall condition based on the degree of crack width.

The inspection tool may include a plurality of substantially transparent reticles positionable on the housing at a focal point of the lens. Each reticle is associated with a different type of tire, and each reticle has a plurality of pairs of indicia marked on a central portion at different spacing on a central portion thereof. Each indicia spacing conforms to a degree of crack width indicating condition of the sidewall of different tires.

In the method and tool described above, the indicia may comprise spaced parallel line pairs. The indicia may indicate whether the degree of crack width places the tire sidewall in different categories of acceptability. The spaced parallel line pairs may be spaced at different distances to determine whether the degree of crack width places the tire sidewall in different categories of acceptability. The spaced parallel line pairs may be color coded to determine whether the degree of crack width places the tire sidewall in different categories of acceptability.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a perspective view of a motor vehicle tire.

FIG. 2 is a close-up side view of a crack on the sidewall of the tire of FIG. 1.

FIG. 3 is a perspective view of an embodiment of the handheld optical tool of the present invention in use inspecting a tire sidewall crack.

FIG. 4 is a plan view of the reticle and indicia employed in the tool of FIG. 3 for measuring sidewall crack width and categorizing the safety of the tire.

FIG. 5 is a plan view of the reticle and indicia of FIG. 4 in use superimposed over and measuring the width of a tire sidewall crack.

FIG. 6 is a plan view of an alternate version of the reticle and indicia of FIG. 5 in use in measuring the width of a sidewall crack for a different type of tire.

FIG. 7 is a plan view of an alternate version of the reticle and indicia of FIG. 5 in use in measuring the width of a sidewall crack for another different type of tire.

FIG. 8 is a perspective view of a different embodiment of the handheld optical tool of FIG. 3 with different reticles for determining crack condition of different types of tires.

### DESCRIPTION OF THE PREFERRED EMBODIMENT(S)

In describing the embodiment of the present invention, reference will be made herein to FIGS. 1-8 of the drawings in which like numerals refer to like features of the invention.

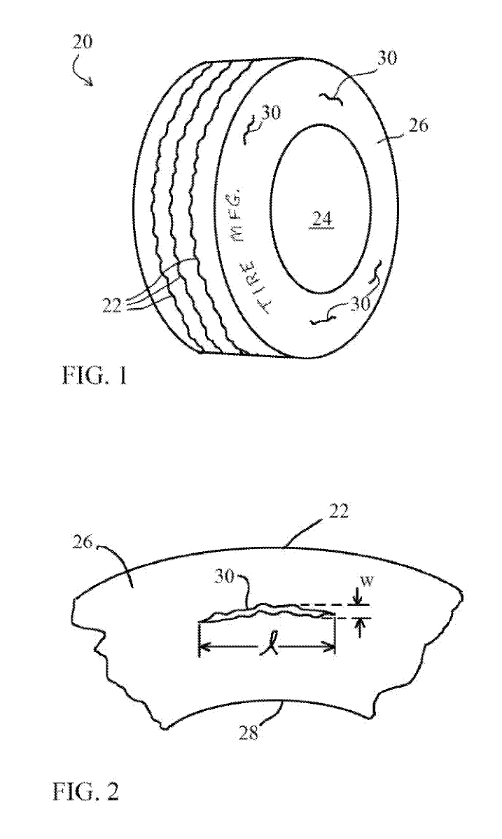

The present invention provides a handheld optical inspection tool, which contains high-magnification optics with an embedded reticle gauge and illumination to allow the user to visually inspect a tire's sidewall for cracks and to compare the cracks to the reticle gauge to allow the user to determine whether the tire sidewall condition as measured by its largest crack width falls within the “acceptable,” “suspect” or “reject” ranges. These ranges may be calibrated in accordance with a source of information that describes different types of “acceptable,” “suspect” or “reject” tire sidewall cracks for the tire or tire type being examined Typical cracks can be measured to have a length l and width w (FIG. 2). The present invention is directed to determination of the crack condition based on its width w and the decision on whether to keep the tire in service or replace it due to safety concerns.

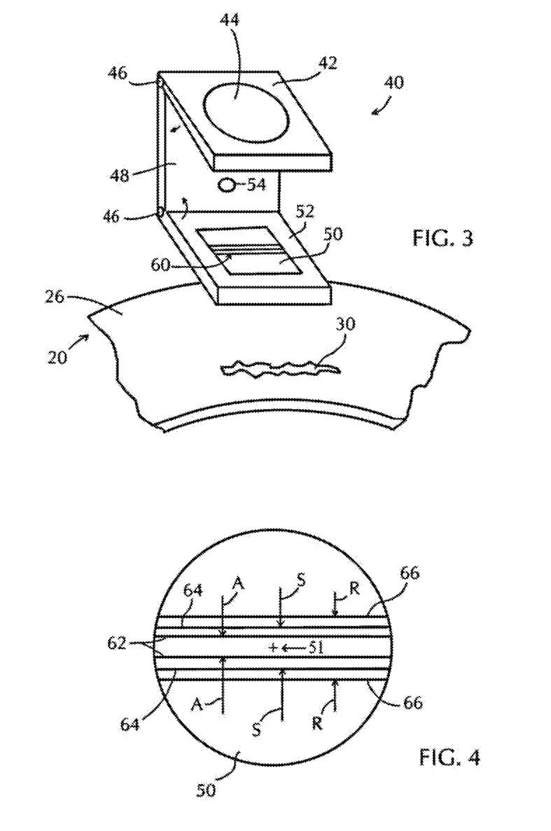

An embodiment of the tire sidewall crack inspection tool 40 is shown initially in FIG. 3 and consists of a housing or back 48 which extends upright to be grasped by the user's hand and a top portion 42 and bottom portion 52 extending perpendicularly outward therefrom. The top and bottom portions are each mounted on and secured by hinges 46 and are foldable in the direction of the arrows toward the back to enable the tool to be placed in the user's pocket when not in use. Except for the reticle discussed below, the tool is similar to a linen thread count magnifier, which utilizes dimensional marks on the tool base outside of the field of view to determine the number of threads per unit length.

The top portion 42 has an eyepiece that includes a lens 44 mounted therein, the sighting of which is directed downward towards base 52. The reticle may be located within bottom portion 52, so that when the top and bottom portions are unfolded, the plane of reticle 50 is positioned at the focal plane of the lens 44. An illumination source 54 with a power supply (not shown) such as a battery powered LED lamp may be used to illuminate the reticle and a tire sidewall under the reticle during inspection through the magnifier lens 44.

The reticle 50 is shown in FIG. 4 in more detail and includes a series of indicia or marks 60 thereon, shown as parallel lines, and visible on a central portion thereof to compare to and measure the width w of a crack on the tire sidewall. The purpose of the indicia is to measure the crack width and place the sidewall in different categories of acceptability. Although the reticle indicia 60 are shown as continuous solid lines, other marks may be used such as dashed or dotted lines, or discrete individual marks. The indicia are employed in pairs, such as the separate, spaced line pairs 62, 64 and 66. Paired indicia may also be opposite ends of a single mark or line. The indicia lines shown are straight line chords that extend from one side of the circular reticle to the other and intersect the perimeter thereof The line pairs are parallel to each other and are positioned equidistant on opposite sides of the center 51 of the reticle field, without passing through the center.

A first pair of lines 66 are spaced farthest apart and are separated by a distance R, which distance conforms to the minimum width w at which a tire crack sidewall dimension indicates rejection of the tire and a need for replacement thereof Within rejection lines 66 are a pair of lines 64 which are spaced by the distance S, conforming to a distance smaller than distance R and indicating that a crack width places the tire sidewall in the suspect category. At this dimension S, the user should examine the crack and tire carefully to determine if there are other indications that the tire needs to be replaced, e.g., the depth of the crack or the number of such cracks having width equal to or greater than spacing S.

Within lines 64 are spaced pairs of lines 62 which indicate that the crack is of acceptable width w, i.e., crack width w is no greater than line pair 62 spacing A. This indicates that the tire sidewall condition does not merit further investigation by the user under normal circumstances.

In operation of the inspection tool, the user first ensures that the reticle 50 is in position on the tool below the lens 44 and then places the tool so that the reticle is directly over the tire sidewall. The user then holds and aligns the inspection device 40 so that the bottom portion 52 is against the sidewall of the tire and looks into the eyepiece while pressing the power switch for the illumination. The user sees the surface of the tire through the lens in higher magnification and through the proportionally scaled reticle indicia 60. The user moves the tool to locate the largest visible surface crack.

The user then moves the tool so that the crack to be inspected is aligned directly under the reticle and rotates the tool with respect to the tire sidewall and orients it so that the axis of crack length 1 is approximately parallel to the indicia lines 60 on the reticle. This also positions the crack width so that the width w direction is aligned along the direction of the shortest line connecting the indicia line pairs. The user may move the reticle in a direction perpendicular to the crack length to position the crack width so that it is over center 51 of reticle field 50. In this relative position the sides of the crack along the width are approximately symmetrically located within, on or outside of the different indicia line pairs.

Once the crack is positioned in this manner relative to the reticle, the user then may see if the crack width w fits within the “acceptable”, “suspect”, or “reject” lines of the gauge. The user would then utilize the indicia lines 62, 64 or 66 on either side of the reticle center 51 to determine whether the crack width w corresponds to the spacing A, S or R, as indicated by the indicia lines 60. If the crack width w were equal to or less than spacing A indicated by line 62, the user would categorize the crack as being “acceptable.” If the crack width w was equal to or greater than spacing S indicated by indicia line 64, the crack would be classified as “suspect” and the user may make further investigation of the severity of the crack and its effect on the safety of the tire sidewall. If the crack width w is equal to or greater than spacing R as indicated by indicia lines 66 then the crack size would be classified as “reject” and indicate that the sidewall should be rejected as being unsafe. For example, 2 mm may be established as the maximum acceptable crack width w, so that any crack widths above this level would be in the “suspect” category, and widths at or above 2.5 or 3 mm or more may be established to place the crack in the “reject” category.

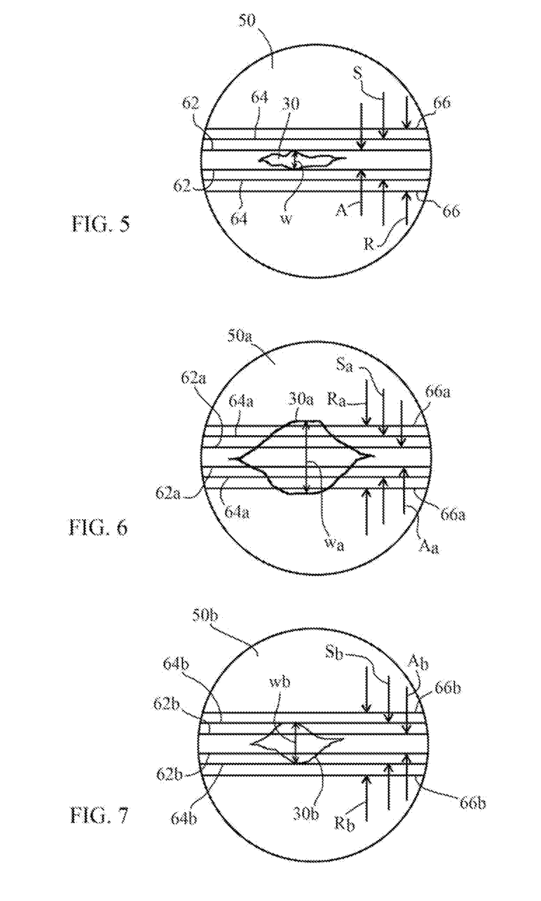

The application of the reticle 50 indicia to measure a tire crack 30 is shown in FIG. 5. In this example, a tire crack 30 has a width w that is approximately the same as spacing A of line 62. Since this spacing A conforms to the “good” or “acceptable” category, measurement of the width of crack 30 by the reticle indicia would indicate to the user that the crack width is acceptable for normal use. If the crack width w were such that it was equal to or greater than width R of indicia line 66, then that would indicate to the user that the tire should be rejected and taken out of use due to excessive crack sidewall width. If the width w of crack 30 were between the two i.e. at the spacing of S of line 64, than the tire would be in the “suspect” category meriting further investigation but not necessarily outright rejection.

Because tires can be made of different rubber compositions and other component materials, one standard set of indicia lines is generally not useful to determine whether the cracks on a tire sidewall are acceptable or not. For example, tires are made from different compounds and have different fillers depending on whether they are made to be used as winter tires, which require good gripping, are made for extended mileage, are made for better fuel economy, or are made for run flat tire applications. Depending on these tire compound and material parameters, different indicia line spacings may be required for each crack category.

FIG. 6 shows one such different spacing where the distances Aₐ, Sₐ, and Rₐ are different on reticle 50a. In this case the spacing of parallel line pairs 62a, 64a, and 66a are all smaller than the comparable distances A, S and R on reticle 50 in FIG. 5. In this example, tire sidewall crack 30a when viewed through reticle 50a using the indicia lines thereon shows that the crack width wₐ is such that it is greater than the line spacing Rₐ and the tire should be rejected.

FIG. 7 shows an example of a reticle 50b in which the spacing dimensions A_{b}, S_{b} and R_{b} for indicia lines 62b, 64b and 66b are all larger than comparable distances A, S and R on reticle 50 in FIG. 5. In this example, crack 30b has a width w_{b} that places it in the approximate dimension S_{b}, meaning that the crack is suspect and merits further investigation.

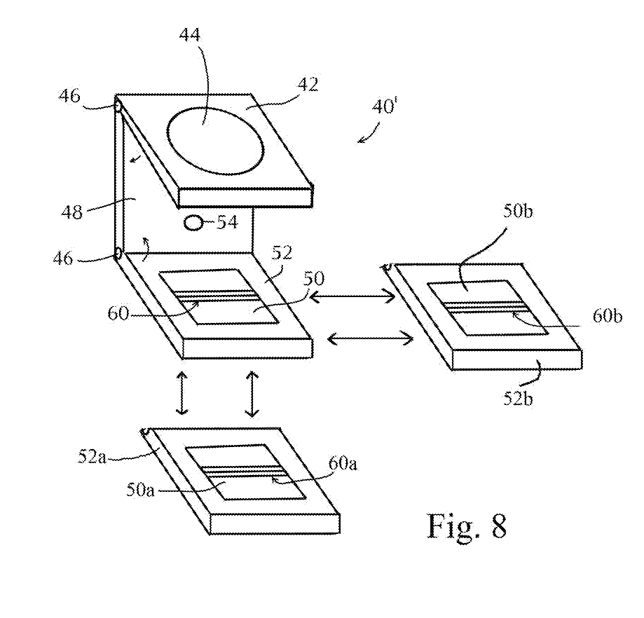

A tool 40′ which may employ multiple reticles to accommodate and measure cracks on different selected tire types is shown in FIG. 8. In this example, tool 40′ has additional reticles 50a, 50b mounted in different bases 52a, 52b, respectively. These reticles have different indicia line sets 60a, 60b, which are analogous to those shown in FIGS. 6 and 7 respectively. Each indicia line set has suitable and correct spacings for the “acceptable,” “suspect” or “reject” ranges for the different tire types.

The additional bases and reticles as shown in FIG. 8 may be provided with the tool in a kit form, with the reticles separate and alternately securable to the tool and positionable with respect to the lens. Alternatively, the different reticles may all be physically connected to the tool housing and alternately positionable with respect to the lens. The tool 40′ may contain more or fewer reticles than shown in FIG. 8. The user would initially determine the manufacturer of the tire, and the type of tire to be inspected. This tire type might be indicated by the brand or model name and other markings on the tire itself The user would then employ a source of information (not shown) to determine which of the different reticles to employ for the selected tire.

The embedded indicia 60 and lines 62, 64, 66 may be coded to differentiate them from each other and to indicate to the user that the tire crack may be classified in the different crack categories as above. For example, the lines may be color coded by any suitable colors. For, example, line pairs 62 indicating an acceptable crack may be colored green, line pairs 64 indicating a crack is suspect may be colored yellow and line pairs 66 indicating a crack is to be rejected may be colored red. Other colors and color combinations may be employed.

Accordingly, the present invention provides an improved method of determining crack condition on a sidewall of a tire and tire sidewall crack inspection tool for categorizing such crack condition. The tool and method easy to are easy carry and use in the field and determine sidewall crack condition based on its width.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A method of determining crack condition on a sidewall of a tire comprising:
providing a crack detection tool having a housing, a lens secured on the housing, at least one substantially transparent reticle positionable on the housing at the focal plane of the lens, and a plurality of spaced pairs of indicia on a central portion of the at least one reticle, the spacing of each pair of indicia conforming to a degree of crack condition of the sidewall of a desired tire;
aligning the at least one reticle against the sidewall of the desired tire;
viewing the sidewall of the desired tire through the lens and the at least one reticle;
selecting a crack on the tire sidewall, the crack having a length and a width and sides along the width;
positioning the at least one reticle over the selected crack so that the sides of the crack are approximately symmetrically located within, on or outside of the pairs of indicia;
using the pairs of indicia on the at least one reticle, determining the tire sidewall condition based on the degree of crack width.

2. The method of claim 1 including providing a plurality of different substantially transparent reticles positionable on the housing at a focal point of the lens, each reticle being associated with a different type of tire, each reticle having a plurality of pairs of indicia marked on a central portion at different spacing on a central portion thereof, each indicia spacing conforming to a degree of crack width indicating condition of the sidewall of different tires.

3. The method of claim 1 wherein the crack selected comprises the largest visible crack on the tire sidewall.

4. The method of claim 1 wherein the indicia comprise spaced parallel line pairs.

5. The method of claim 1 wherein the indicia indicate whether the degree of crack width places the tire sidewall in different categories of acceptability.

6. The method of claim 1 wherein the indicia comprise spaced parallel line pairs that indicate whether the degree of crack width places the tire sidewall in different categories of acceptability.

7. The method of claim 1 wherein the indicia comprise spaced parallel line pairs that are spaced at different distances to determine whether the degree of crack width places the tire sidewall in different categories of acceptability.

8. The method of claim 1 wherein the spaced parallel line pairs are color coded to determine whether the degree of crack width places the tire sidewall in different categories of acceptability.

9. A method of determining crack condition on a sidewall of a tire comprising:
providing a crack detection tool having a housing, a lens secured on the housing, a plurality of different substantially transparent reticles positionable on the housing at a focal point of the lens, each reticle being associated with a different type of tire, each reticle having a plurality of pairs of indicia marked on a central portion at different spacing on a central portion thereof, each indicia spacing conforming to a degree of crack width indicating condition of the sidewall of different tires;
selecting a reticle for a desired tire;
aligning the selected reticle against the sidewall of the desired tire;
viewing the sidewall of the desired tire through the lens and the selected reticle;
selecting a crack on the tire sidewall, the crack having a length and a width and sides along the width;
positioning the selected reticle over the selected crack so that the sides of the crack are approximately symmetrically located within, on or outside of the pairs of indicia;
using the pairs of indicia on the selected reticle, determining the tire sidewall condition based on the degree of crack width.

10. The method of claim 9 wherein the crack selected comprises the largest visible crack on the tire sidewall.

11. The method of claim 9 wherein the indicia comprise spaced parallel line pairs.

12. The method of claim 9 wherein the indicia comprise spaced parallel line pairs that are spaced at different distances to determine whether the degree of crack width places the tire sidewall in different categories of acceptability.

13. The method of claim 9 wherein the spaced parallel line pairs are color coded to determine whether the degree of crack width places the tire sidewall in different categories of acceptability.

14. A tire sidewall crack inspection tool comprising:
a tool housing;
a lens secured on the housing;
at least one substantially transparent reticle positionable on the housing at a focal plane of the lens, the at least one reticle being associated with a desired type of tire; and
a plurality of spaced pairs of indicia marked on a central portion of the at least one reticle, the spacing of each pair of indicia conforming to a different degree of crack condition of the sidewall of a desired tire,
whereby the reticle for the desired tire may be aligned against the sidewall of the desired tire to permit viewing of a crack on the sidewall of the desired tire through the lens and the plurality of pairs of indicia on the reticle may be used to determine the tire sidewall condition based on the degree of crack width.

15. The tool of claim 14 including a plurality of substantially transparent reticles positionable on the housing at a focal point of the lens, each reticle being associated with a different type of tire, each reticle having a plurality of pairs of indicia marked on a central portion at different spacing on a central portion thereof, each indicia spacing conforming to a degree of crack width indicating condition of the sidewall of different tires.

16. The tool of claim 14 wherein the indicia comprise spaced parallel line pairs.

17. The tool of claim 14 wherein the indicia indicate whether the degree of crack width places the tire sidewall in different categories of acceptability.

18. The tool of claim 14 wherein the indicia comprise spaced parallel line pairs that indicate whether the degree of crack width places the tire sidewall in different categories of acceptability.

19. The tool of claim 14 wherein the indicia comprise spaced parallel line pairs that are spaced at different distances to determine whether the degree of crack width places the tire sidewall in different categories of acceptability.

20. The tool of claim 14 wherein the spaced parallel line pairs are color coded to determine whether the degree of crack width places the tire sidewall in different categories of acceptability.
